(19) United States
(12) Patent Application Publication
(10) Pub. No.: US 2026/0178960 A1
(43) Pub. Date: Jun. 25, 2026

(54) INFORMATION PROCESSING APPARATUS, INFORMATION PROCESSING METHOD, AND NON-TRANSITORY RECORDING MEDIUM

(71) Applicant: NEC Corporation, Minato-ku, Tokyo (JP)

(72) Inventors: Akinori EBIHARA, Tokyo (JP); Taiki MIYAGAWA, Tokyo (JP)

(73) Assignee: NEC Corporation, Minato-ku, Tokyo (JP)

(21) Appl. No.: 18/832,995

(22) PCT Filed: Feb. 2, 2022
(86) PCT No.: PCT/JP2022/004080

§ 371 Date: Jul. 25, 2024

(51) Int. Cl. G06N 20/00

(52) U.S. Cl. CPC G06N 20/00

(57) ABSTRACT

An information processing apparatus includes: an acquisition unit that acquires a plurality of elements included in series data; a calculation unit that calculates a likelihood ratio indicating a likelihood of a class to which the series data belong, on the basis of at least two consecutive elements of the plurality of elements; a classification unit that classifies the serial data into at least one class of multiple classes serving as classification candidates, on the basis of the likelihood ratio; and a learning unit that performs learning about calculation of the likelihood ratio, by using a loss function for decomposing the likelihood ratio into a sum of multiple terms. According to the information processing apparatus, it is possible to realize high-precision class classification by performing appropriate learning.

### TECHNICAL FIELD

This disclosure relates to technical fields of an information processing apparatus, an information processing method, and a recording medium.

### BACKGROUND ART

A known apparatus of this type classifies data into classes. For example, Patent Literature 1 discloses a technique/technology of classifying series data into any of predetermined multiple classes, by sequentially acquiring and analyzing a plurality of elements included in the series data. Patent Literature 2 discloses that movement trajectories included in an image subset classified into subclasses, that the same subclass label is given to those having a high sharing ratio of the subclasses, and that the respective subclasses are classified into classes.

As another related technology/technique, for example, Patent Literature 3 discloses that KL-divergence (Kullback-Leibler divergence) is used in an apparatus that determines a domain of a sentence. Patent Literature 4 discloses that a posterior probability is calculated to determine whether or not a person in question is the same person in a biometric authentication apparatus.

### CITATION LIST

### Patent Literature

Patent Literature 1: International Publication No. WO2020/194497
Patent Literature 2: International Publication No. WO2012/127815
Patent Literature 3: JP2019-036286A
Patent Literature 4: JP2009-289253A

### SUMMARY

### Technical Problem

This disclosure aims to improve the techniques/technologies disclosed in Citation List.

### Solution to Problem

An information processing apparatus according to an example aspect of this disclosure includes: an acquisition unit that acquires a plurality of elements included in series data; a calculation unit that calculates a likelihood ratio indicating a likelihood of a class to which the series data belong, on the basis of at least two consecutive elements of the plurality of elements; a classification unit that classifies the serial data into at least one class of multiple classes serving as classification candidates, on the basis of the likelihood ratio; and a learning unit that performs learning about calculation of the likelihood ratio, by using a loss function for decomposing the likelihood ratio into a sum of multiple terms.

An information processing method according to an example aspect of this disclosure includes: acquiring a plurality of elements included in series data; calculating a likelihood ratio indicating a likelihood of a class to which the series data belong, on the basis of at least two consecutive elements of the plurality of elements; classifying the serial data into at least one class of multiple classes serving as classification candidates, on the basis of the likelihood ratio; and performing learning about calculation of the likelihood ratio, by using a loss function for decomposing the likelihood ratio into a sum of multiple terms.

A recording medium according to an example aspect of this disclosure is a recording medium on which a computer program that allows at least one computer to execute an information processing method is recorded, the information processing method including: acquiring a plurality of elements included in series data; calculating a likelihood ratio indicating a likelihood of a class to which the series data belong, on the basis of at least two consecutive elements of the plurality of elements; classifying the serial data into at least one class of multiple classes serving as classification candidates, on the basis of the likelihood ratio; and performing learning about calculation of the likelihood ratio, by using a loss function for decomposing the likelihood ratio into a sum of multiple terms.

### BRIEF DESCRIPTION OF DRAWINGS

FIG. 1 is a block diagram illustrating a hardware configuration of an information processing apparatus according to a first example embodiment.

FIG. 2 is a block diagram illustrating a functional configuration of the information processing apparatus according to the first example embodiment.

FIG. 3 is a flowchart illustrating a flow of operation of the classification apparatus in the information processing apparatus according to the first example embodiment.

FIG. 4 is a flowchart illustrating a flow of operation of a learning unit in the information processing apparatus according to the first example embodiment.

FIG. 5A is a graph illustrating an example of a likelihood ratio calculated by an information processing apparatus according to a comparative example and a likelihood ratio calculated by the information processing apparatus according to the first example embodiment.

FIG. 5B is a graph illustrating an example of a likelihood ratio calculated by an information processing apparatus according to a comparative example and a likelihood ratio calculated by the information processing apparatus according to the first example embodiment.

FIG. 6 is a conceptual diagram illustrating an operation example of neural networks in an information processing apparatus according to a second example embodiment.

FIG. 7 is a block diagram illustrating a functional configuration of an information processing apparatus according to a sixth example embodiment.

FIG. 8 is a flowchart illustrating a flow of the operation of a classification apparatus in the information processing apparatus according to the sixth example embodiment.

FIG. 9 is a block diagram illustrating a functional configuration of an information processing apparatus according to a seventh example embodiment.

FIG. 10 is a flowchart illustrating a flow of operation of a likelihood ratio calculation unit in the information processing apparatus according to the seventh example embodiment.

### DESCRIPTION OF EXAMPLE EMBODIMENTS

Hereinafter, an information processing apparatus, an information processing method, and a recording medium according to example embodiments will be described with reference to the drawings.

### First Example Embodiment

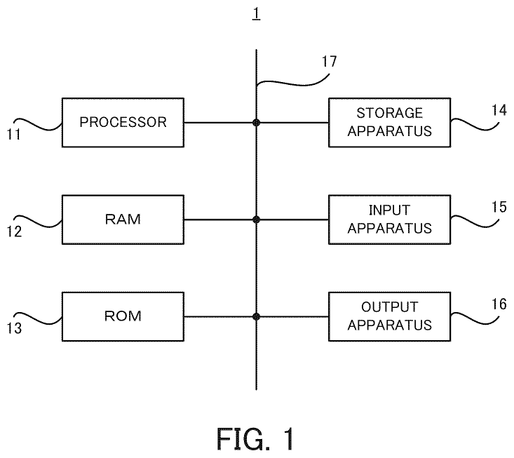

An information processing apparatus according to a first example embodiment will be described with reference to FIG. 1 to FIG. 5.

### (Hardware Configuration)

First, with reference to FIG. 1, a hardware configuration of the information processing apparatus according to the first example embodiment will be described. FIG. 1 is a block diagram illustrating the hardware configuration of the information processing apparatus according to the first example embodiment.

As illustrated in FIG. 1, an information processing apparatus 1 according to the first example embodiment includes a processor 11, a RAM (Random Access Memory) 12, a ROM (Read Only Memory) 13, and a storage apparatus 14. The information processing apparatus 1 may further include an input apparatus 15 and an output apparatus 16. The processor 11, the RAM 12, the ROM 13, the storage apparatus 14, the input apparatus 15, and the output apparatus 16 are connected through a data bus 17.

The processor 11 reads a computer program. For example, the processor 11 is configured to read a computer program stored by at least one of the RAM 12, the ROM 13 and the storage apparatus 14. Alternatively, the processor 11 may read a computer program stored in a computer-readable recording medium, by using a not-illustrated recording medium reading apparatus. The processor 11 may acquire (i.e., may read) a computer program from a not-illustrated apparatus disposed outside the information processing apparatus 1, through a network interface. The processor 11 controls the RAM 12, the storage apparatus 14, the input apparatus 15, and the output apparatus 16 by executing the read computer program. Especially in the present example embodiment, when the processor 11 executes the read computer program, a functional block for performing class classification based on a likelihood ratio is realized or implemented in the processor 11. That is, the processor 11 may function as a controller for executing each control in the information processing apparatus 1.

The processor 11 may be configured as, for example, a CPU (Central Processing Unit), a GPU (Graphics Processing Unit), a FPGA (Field-Programmable Gate Array), a DSP (Demand-Side Platform), or an ASIC (Application Specific Integrated Circuit). The processor 11 may be one of them, or may use a plurality of them in parallel.

The RAM 12 temporarily stores the computer program to be executed by the processor 11. The RAM 12 temporarily stores data that are temporarily used by the processor 11 when the processor 11 executes the computer program. The RAM12 may be, for example, a D-RAM (Dynamic Random Access Memory) or a SRAM (Static Random Access Memory). Furthermore, another type of volatile memory may also be used instead of the RAM12.

The ROM 13 stores the computer program to be executed by the processor 11. The ROM 13 may otherwise store fixed data. The ROM13 may be, for example, a P-ROM (Programmable Read Only Memory) or an EPROM (Erasable Read Only Memory). Furthermore, another type of non-volatile memory may also be used instead of the ROM13.

The storage apparatus 14 stores data that are stored by the information processing apparatus 1 for a long time. The storage apparatus 14 may operate as a temporary/transitory storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the information processing apparatus 1. The input apparatus 15 may include, for example, at least one of a keyboard, a mouse, and a touch panel. The input apparatus 15 may be configured as a portable terminal such as a smartphone and a tablet. The input apparatus 15 may be an apparatus that allows audio input/voice input, including a microphone, for example.

The output apparatus 16 is an apparatus that outputs information about the information processing apparatus 1 to the outside. For example, the output apparatus 16 may be a display apparatus (e.g., a display) that is configured to display the information about the information processing apparatus 1. The output apparatus 16 may be a speaker or the like that is configured to audio-output the information about the information processing apparatus 1. The output apparatus 16 may be configured as a portable terminal such as a smartphone and a tablet. The output apparatus 16 may be an apparatus that outputs information in a form other than an image. For example, the output apparatus 16 may be a speaker that audio-outputs the information about the information processing apparatus 1.

Although FIG. 1 illustrates an example of the information processing apparatus 1 including a plurality of apparatuses, all or a part of the functions may be realized or implemented as a single apparatus. Such an information processing apparatus may include, for example, only the processor 11, the RAM 12, and the ROM 13. The other components (i.e., the storage apparatus 14, the input apparatus 15, the output apparatus 16, etc.) may be provided in an external apparatus connected to the information processing apparatus 1, for example. In addition, in the information processing apparatus 1, a part of an arithmetic function may be realized by an external apparatus (e.g., an external server or cloud, etc.).

### (Functional Configuration)

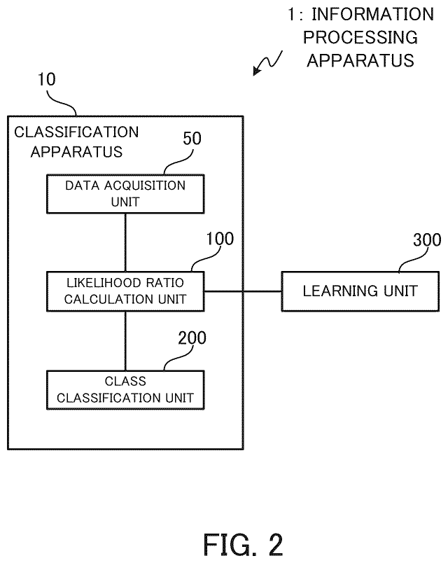

Next, with reference to FIG. 2, a functional configuration of the information processing apparatus 1 according to the first example embodiment will be described. FIG. 2 is a block diagram illustrating the functional configuration of the information processing apparatus according to the first example embodiment.

As illustrated in FIG. 2, the information processing apparatus 1 according to the first example embodiment includes a classification apparatus 10 and a learning unit 300. The classification apparatus 10 is an apparatus that classifies input series data into classes, and includes, as processing blocks for realizing the functions thereof, a data acquisition unit 50, a likelihood ratio calculation unit 100, and a class classification unit 200. Furthermore, the learning unit 300 is configured to perform learning processing about the classification apparatus 10. Although the learning unit 300 is provided separately from the classification apparatus 10 in this example, the classification apparatus 10 may include the learning unit 300. Each of the data acquisition unit 50, the likelihood ratio calculation unit 100, the class classification unit 200, and the learning unit 300 may be realized or implemented by the processor 11 (see FIG. 1).

The data acquisition unit 50 is configured to acquire a plurality of elements included in the series data. The data acquisition unit 50 may acquire data directly from an arbitrary data acquisition apparatus (e.g., a camera or a microphone, etc.), or may read data that are acquired in advance by the data acquisition apparatus and are stored in a storage or the like. When acquiring data from a camera, the data acquisition unit 50 may be configured to acquire the data from each of a plurality of cameras. The elements of the sequence data acquired by the data acquisition unit 50 are configured to be outputted to the likelihood ratio calculation unit 100. The series data are data including a plurality of elements arranged in a predetermined order, and an example thereof is, for example, time series data. A more specific example of the series data is, but is not limited to, video data and audio data.

The likelihood ratio calculation unit 100 is configured to calculate a likelihood ratio on the basis of at least two consecutive elements of the plurality of elements acquired by the data acquisition unit 50. The “likelihood ratio” here is an index indicating a likelihood of a class to which the serial data belong. A specific example and a specific calculation method of the likelihood ratio will be described in detail in another example embodiment later.

The class classification unit 200 is configured to classify the series data on the basis of the likelihood ratio calculated by the likelihood ratio calculation unit 100. The class classification unit 200 selects at least one class to which the series data belong, from among multiple classes serving as classification candidates. The multiple classes serving as classification candidates may be set in advance. Alternatively, the multiple classes serving as classification candidates may be set by the user as appropriate, or may be set as appropriate on the basis of a type of the series data to be handled or the like. The number of the multiple classes serving as classification candidates may be 2, or may be 3 or more.

The learning unit 300 performs learning about calculation of the likelihood ratio by using a loss function. Specifically, the learning unit 300 performs the learning about the calculation of the likelihood ratio such that class classification based on the likelihood ratio is accurately performed. The loss function used by the learning unit 300 according to this example embodiment is a loss function for decomposing the likelihood ratio into a sum of multiple terms. The loss function may be set in advance as a function satisfying the above definition. A specific example of the loss function will be described in detail in another example embodiment later.

### (Flow of Classification Operation)

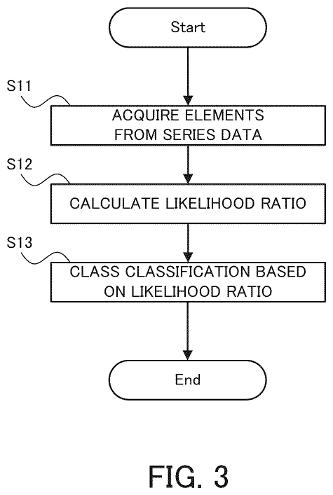

Next, with reference to FIG. 3, a flow of operation of the classification apparatus 10 (specifically, a class classification operation after learning) in the information processing apparatus 1 according to the first example embodiment will be described. FIG. 3 is a flowchart illustrating the flow of the operation of the classification apparatus in the information processing apparatus according to the first example embodiment.

As illustrated in FIG. 3, when the operation of the classification apparatus 10 is started, first, the data acquisition unit 50 acquires the elements included in the series data (step S11). The data acquisition unit 50 outputs the acquired elements of the sequence data to the likelihood ratio calculation unit 100. Then, the likelihood ratio calculation unit 100 calculates the likelihood ratio on the basis of the acquired two or more elements (step S12).

Subsequently, the class classification unit 200 performs the class classification on the basis of the calculated likelihood ratio (step S13). The class classification may determine one class to which the series data belong, or may determine multiple classes to which the series data are likely to belong. The class classification unit 200 may output a result of the class classification to a display or the like. The class classification unit 200 may also output the result of the class classification by audio through a speaker or the like.

The class classification unit 200 may calculate the likelihood ratio again without performing the class classification (i.e., without determining the class into which the series data are classified) when the calculated likelihood ratio does not exceed a predetermined threshold (i.e., a threshold for determining into which class the series data are classified). In this instance, the data acquisition unit 50 newly acquires elements included in the series data, by which a new likelihood ratio may be calculated.

### (Flow of Learning Operation)

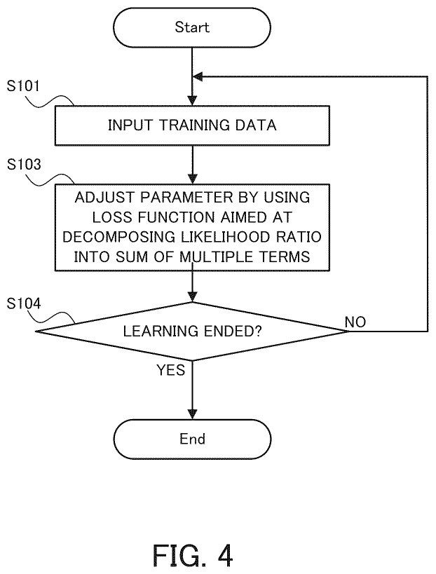

Next, with reference to FIG. 4, a flow of operation of the learning unit 300 (i.e., a learning operation about the calculation of the likelihood ratio) in the information processing apparatus 1 according to the first example embodiment will be described. FIG. 4 is a flowchart illustrating the flow of the operation of the learning unit in the information processing apparatus according to the first example embodiment.

As illustrated in FIG. 4, when the learning operation is started, first, training data are inputted to the learning unit 300 (step S101). The training data may be configured, for example, as a set of the serial data and information about a correct answer class to which the serial data belong (i.e., correct data).

Subsequently, the learning unit 300 calculates the loss function by using the inputted training data (step S102). The loss function here is, as already described, a loss function for decomposing the likelihood ratio into the sum of multiple terms.

Subsequently, the learning unit 300 adjusts a parameter on the basis of the calculated loss function (step S103). Specifically, the learning unit 300 adjusts the parameter of a model for calculating the likelihood ratio so as to reduce the loss function. In this way, the learning unit 300 optimizes the parameter of the model for calculating the likelihood ratio. As a method of optimizing the parameter using the loss function, existing techniques/technologies may be employed as appropriate. An example of the optimization method is error back propagation, but another method may be also used.

Thereafter, the learning unit 300 determines whether or not all the learning is ended (step S104). The learning unit 300 may determine whether or not the learning is ended, for example, on the basis of a predetermined number of iterations.

When it is determined that all learning is ended (the step S104: YES), a series of processing steps is ended. On the other hand, when it is determined that all the learning is not ended (the step S104: NO), the learning unit 300 starts the processing from the step S101 again.

By this, the learning processing using the training data is repeated, thereby adjusting the parameter to be more optimal.

### (Technical Effect)

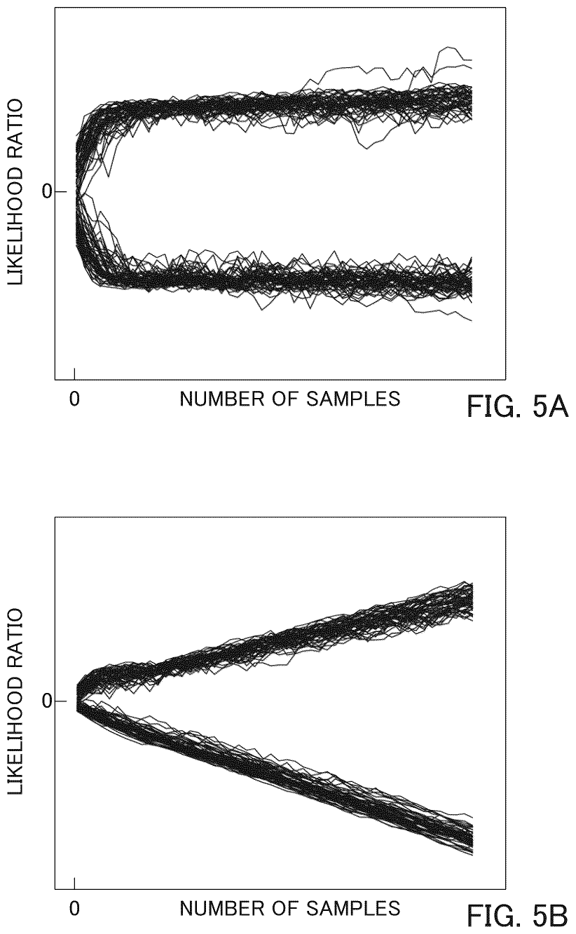

Next, with reference to FIGS. 5A and 5B, a technical effect obtained by the information processing apparatus 1 according to the first example embodiment will be described. FIGS. 5A and 5B are a graph illustrating an example of a likelihood ratio calculated by an information processing apparatus according to a comparative example and the likelihood ratio calculated by the information processing apparatus according to the first example embodiment.

As illustrated in FIG. 5A, in the information processing apparatus according to the comparative example (i.e., the information processing apparatus that does not perform the learning using the loss function for decomposing the likelihood ratio into the sum of multiple terms, unlike the present example embodiment), although the likelihood ratio tends to increase or decrease as the number of samples (i.e., the number of the serial data acquired) increases, a change in the likelihood ratio may reach its peak. That is, even if more data are accumulated, the change in the likelihood ratio may be reduced. This may be because there is a correlation between the serial data.

On the other hand, as illustrated in FIG. 5B, in the information processing apparatus 1 according to the first example embodiment, the likelihood ratio increases or decreases as the number of samples increases, and the change does not reach its peak. That is, as more data are accumulated, the likelihood ratio increases or decreases in the same manner as before. This may be because it is possible to realize the independence of an output (likelihood ratio).

In a case where the class classification is performed by using the likelihood ratio, the classification may be properly performed (e.g., the classification may be performed with a small number of samples) when the likelihood ratio increases or decreases as illustrated in FIG. 5B, rather than when the change in the likelihood ratio reaches its peak as illustrated in FIG. 5A. Therefore, according to the information processing apparatus 1 in the first example embodiment, it is possible to realize more appropriate class classification by performing the learning using the loss function for decomposing the likelihood ratio into the sum of multiple terms.

### Second Example Embodiment

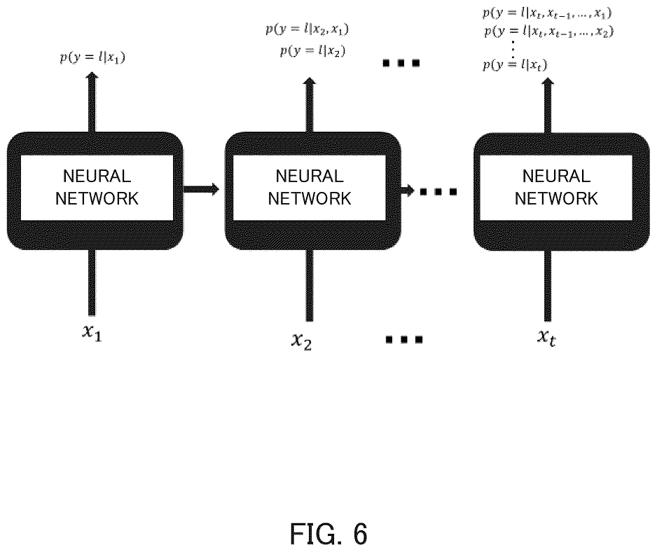

The information processing apparatus 1 according to a second example embodiment will be described with reference to FIG. 6. The second example embodiment describes a specific method of setting the loss function used in the first example embodiment, and may be the same as the first example embodiment in the apparatus configuration (see FIG. 1 and FIG. 2), the classification operation (see FIG. 3), and the learning operation (see FIG. 4), or the like, for example. For this reason, a part that is different from the first example embodiment will be described in detail below, and a description of the other overlapping parts will be omitted as appropriate.

### (Method of Setting Loss Function)

First, the method of setting the loss function used in the information processing apparatus 1 according to the second example embodiment (i.e., the loss function used by the learning unit 300) will be described. The loss function used in the information processing apparatus 1 according to the second example embodiment is a loss function set on the assumption that a prior distribution is uniform. The following describes this assumption that the prior distribution is uniform with reference to FIG. 6. FIG. 6 is a conceptual diagram illustrating an operation example of neural networks in the information processing apparatus according to the second example embodiment.

As illustrated in FIG. 6, let us assume that the information processing apparatus 1 according to the second example embodiment processes data by using the neural networks. The plurality of neural networks illustrated are those that are common in a time direction (having the same network structure and the same parameter). x (i.e., x₁, x₂, . . . , xₜ) inputted to the neural networks is random variables and is inputted one by one at each time. x may be raw data, or may be pre-processed in another neural network. p(y=l|x) outputted from the neural network is a posterior probability. Here, l represents a particular class. For example, p (y=l|x₁) is a value indicating the probability that the random variable x₁ is classified into a class l.

Here, in particular, assuming that the prior distribution is uniform, it is possible to guarantee the independence of the output of the neural network by imposing such a condition that the posterior probability can be decomposed as in equations (1) and (2) below.

$$\begin{matrix}[ Equation 1 ] & \\ ρ ( y = l \vert {x}_{1} , {x}_{2} ) = ρ ( y = l \vert {x}_{1} ) ρ ( y = l \vert {x}_{2} ) & ( 1 )\end{matrix}$$

$$ρ ( y = k \vert {x}_{1} , {x}_{2} ) = ρ ( y = k \vert {x}_{1} ) ρ ( y = k \vert x ) \qquad ( 2 )$$

It is because a ratio of the posterior probabilities may be transformed as in equations (3) to (5) below by using Bayes' theorem.

$$\begin{matrix}[ Equation 2 ] & \\ \frac{ρ ( y = k \vert {x}_{1} , {x}_{2} )}{ρ ( y = l \vert {x}_{1} , {x}_{2} )} = \frac{ρ ( {x}_{1} , {x}_{2} \vert y = k ) ρ ( y = k )}{ρ ( {x}_{1} , {x}_{2} \vert y = l ) ρ ( y = l )} & ( 3 )\end{matrix}$$

$$= \frac{ρ ( y = k \vert {x}_{1} ) ρ ( y = k \vert {x}_{2} )}{ρ ( y = l \vert {x}_{1} ) ρ ( y = l \vert {x}_{2} )} \qquad ( 4 )$$

$$= \frac{ρ ( {x}_{1} \vert y = k ) ρ ( {x}_{2} \vert y = k )}{ρ ( {x}_{1} \vert y = l ) ρ ( {x}_{2} \vert y = l )} ( \frac{ρ ( y = k )}{ρ ( y = l )} ) \hat{} 2 \qquad ( 5 )$$

Specifically, assuming that the prior distribution is uniform, the term p(y=k)/p(y=l) in the equation (3) disappears. Similarly, the term {p(y=k)/p(y=l)}² in the equation (5) also disappears. As a result, it can be seen that the posterior probability can be decomposed as in the equations (1) and (2). Therefore, by using the loss function set on the assumption that the prior distribution is uniform, the independence of the likelihood ratio to be outputted is guaranteed. A specific example of the loss function set in this way will be described in another example embodiment later.

### (Technical Effect)

Next, a technical effect obtained by the information processing apparatus 1 according to the second example embodiment will be described.

The information processing apparatus 1 according to the second example embodiment uses the loss function set on the assumption that the prior distribution is uniform, as described above. As a result, the independence of the likelihood ratio to be outputted is guaranteed, and it is thus possible to realize more appropriate class classification. Since it is assumed that the prior distribution is uniform in the present example embodiment, there is a possibility that the accuracy of the likelihood ratio and the classification may be reduced in a case where this assumption significantly breaks down. If, however, the prior distribution is not perfectly uniform, but can be considered to be close to uniform, then, it is possible to obtain the technical effect described above accordingly.

### Third Example Embodiment

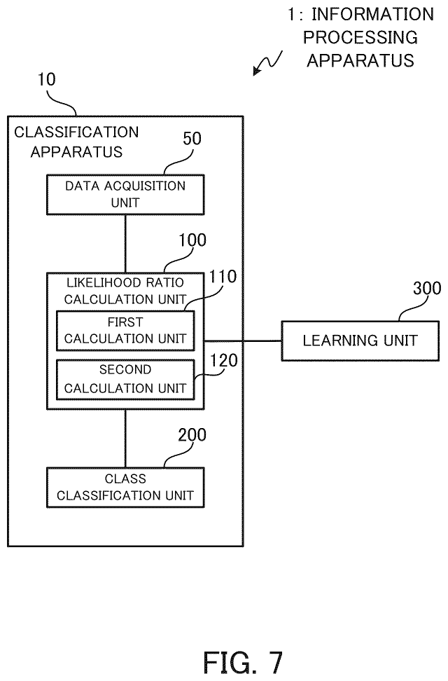

The information processing apparatus 1 according to a third example embodiment will be described with reference to FIG. 7. The third example embodiment describes a specific example of the loss function set in the second example embodiment, and may be the same as the first and second example embodiments in the other portions. For this reason, a part that is different from each of the example embodiments described above will be described in detail below, and a description of the other overlapping parts will be omitted as appropriate.

### (Specific Example of Loss Function)

First, a specific example of the loss function used in the information processing apparatus 1 according to the third example embodiment (i.e., the loss function used by the learning unit 300) will be described. The loss function used in the information processing apparatus 1 according to the third example embodiment includes Kullback-Leibler divergence. Specifically, when using the Kullback-Leibler divergence as in the following equation (6), as its value approaches zero, the random variables get closer to be independent. Consequently, the likelihood ratio is obtained by a sum of simple log (logarithm). Here, E is an expected value in the data direction, and may also be obtained as an arithmetic average value, for example.

$$\begin{matrix}[ Equation 3 ] & \\ {D}_{{KL}_{l}} = E [ log \frac{p ( y = l \vert {x}_{1} , {x}_{2} {…x}_{t} )}{p ( y = l \vert {x}_{1} ) p ( y = l \vert {x}_{2} ) …p ( y = l \vert {x}_{t} )} ] & ( 6 )\end{matrix}$$

In the above equation (6), the denominator of log is the product of the likelihood for each posterior probability, and the numerator is the likelihood that takes into account all the posterior probabilities. In this case, when the denominator matches the numerator, a value inside the log is 1, and the Kullback-Leibler divergence becomes smaller. Therefore, by performing the learning that reduces the Kullback-Leibler divergence (i.e., the loss function), the independence of the likelihood ratio to be outputted is guaranteed.

### (Technical Effect)

Next, a technical effect obtained by the information processing apparatus 1 according to the third example embodiment will be described.

In the information processing apparatus 1 according to the third example embodiment, the learning is performed by using the loss function including the Kullback-Leibler divergence as described above. Thus, the independence of the likelihood ratio to be outputted is guaranteed, and it is thus possible to realize more appropriate class classification.

### Fourth Example Embodiment

The information processing apparatus 1 according to a fourth example embodiment will be described. The fourth example embodiment, as in the second and third example embodiments, describes a specific example of the loss function, and may be the same as the first to third example embodiments in the other parts. For this reason, a part that is different from each of the example embodiments described above will be described in detail below, and a description of the other overlapping parts will be omitted as appropriate.

### (Method of Setting Loss Function)

First, the method of setting the loss function used in the information processing apparatus 1 according to the fourth example embodiment (i.e., the loss function used by the learning unit 300) will be described. The loss function used in the information processing apparatus 1 according to the fourth example embodiment is intended to decompose the likelihood ratio into a first likelihood ratio calculated for each of the plurality of elements and a second likelihood ratio calculated for the entire series data. Specifically, the loss function according to the fourth example embodiment is set such that the likelihood ratio (density ratio) satisfies a condition of the following equation (7). E may be calculated for two selected combinations of l and k from all the classes and the data direction.

$$\begin{matrix}[ Equation 4 ] & \\ {D}_{{L}^{2}} = E [ {( {\sum }_{i = 1}^{T} log \frac{p ( {x}_{i} \vert y = k )}{p ( {x}_{i} \vert y = l )} - log \frac{p ( {x}_{1} , {x}_{2} , … , {x}_{T} \vert y = k )}{p ( {x}_{1} , {x}_{2} , … , {x}_{T} \vert y = l )} )}^{2} ] & ( 7 )\end{matrix}$$

In the above equation (7), the first term in the sigma corresponds to the first likelihood ratio calculated for each of the plurality of elements, and the second term corresponds to the second likelihood ratio calculated for the entire series data. Here, in a case where the plurality of elements (i.e., the random variables x) are independent, the first term matches the second term. Therefore, by performing the learning using the loss function that minimizes a difference between the two terms, the independence of the likelihood ratio to be outputted is guaranteed.

### (Technical Effect)

Next, a technical effect obtained by the information processing apparatus 1 according to the fourth example embodiment will be described.

In the information processing apparatus 1 according to the fourth example embodiment, as described above, the learning is performed by using the loss function for decomposing the likelihood ratio into the first likelihood ratio calculated for each of the plurality of elements and the second likelihood ratio calculated for the entire series data. By this, the independence of the likelihood ratio to be outputted is guaranteed, and it is thus possible to realize more appropriate class classification.

### Fifth Example Embodiment

The information processing apparatus 1 according to a fifth example embodiment will be described. The fifth example embodiment, as in the second to fourth example embodiments, describes a specific example of the loss function, and may be the same as the first to fourth example embodiments in the other parts. For this reason, a part that is different from each of the example embodiments described above will be described in detail below, and a description of the other overlapping parts will be omitted as appropriate.

### (Learning Using Loss Functions)

First, the loss function used in the information processing apparatus 1 according to the fifth example embodiment (i.e., the loss function used by the learning unit 300) will be described. In the information processing apparatus 1 according to the fifth example embodiment, another loss function is used in combination with the loss function used in each of the above-described example embodiments (i.e., the loss function for decomposing the likelihood ratio into the sum of multiple terms). That is, in the fifth example embodiment, the loss function for decomposing the likelihood ratio into the sum of multiple terms and at least another one loss function are used.

The other loss functions used in combination may be various existing loss functions, and are not particularly limited. For example, the loss function used in combination may be a cross-entropy error for classification problems. Alternatively, the loss function used in combination may be a LLLR, a LSEL, or the like for estimation of the likelihood ratio. The loss function used in combination may be determined, for example, in accordance with an operating state of the apparatus. That is, the loss function used in combination may be determined depending on what type of data is to be handled, or into what class the data are classified. An existing method may be properly employed for a learning method using a plurality of loss functions (i.e., a learning method using two or more loss functions).

### (Technical Effect)

Next, a technical effect obtained by the information processing apparatus 1 according to the fifth example embodiment will be described.

In the information processing apparatus 1 according to the fifth example embodiment, the learning using a plurality of loss functions is performed as described above. Therefore, it is possible to perform more appropriate learning than the learning using only the loss function for decomposing the likelihood ratio into the sum of multiple terms. As a result, it is possible to realize more appropriate class classification.

### Sixth Example Embodiment

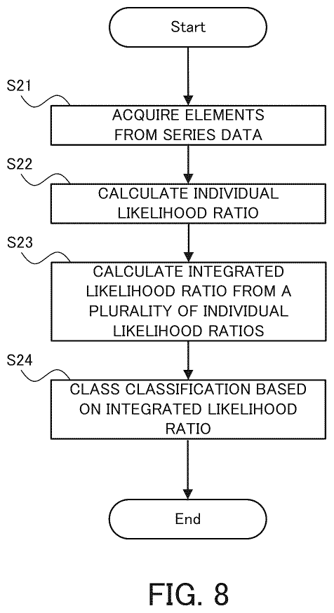

The information processing apparatus 1 according to a sixth example embodiment will be described with reference to FIG. 7 and FIG. 8. The sixth example embodiment is partially different from the first to fifth forms only in the configuration and operation (specifically, the configuration and operation of the classification apparatus 10), and may be the same as the first to fifth example embodiments in the other parts. For this reason, a part that is different from each of the example embodiments described above will be described in detail below, and a description of the other overlapping parts will be omitted as appropriate.

### (Functional Configuration)

First, with reference to FIG. 7, a functional configuration of the information processing apparatus 1 according to the sixth example embodiment will be described. FIG. 7 is a block diagram illustrating the functional configuration of the information processing apparatus according to the sixth example embodiment. In FIG. 7, the same components as those illustrated in FIG. 2 carry the same reference numerals.

As illustrated in FIG. 7, in the information processing apparatus 1 according to the sixth example embodiment, the likelihood ratio calculation unit 100 of the classification apparatus 10 includes a first calculation unit 110 and a second calculation unit 120. Each of the first calculation unit 110 and the second calculation unit 120 may be realized or implemented by the processor 11 (see FIG. 1), for example.

The first calculation unit 110 is configured to calculate an individual likelihood ratio on the basis of two consecutive elements included in the series data. The individual likelihood ratio is calculated as a likelihood ratio indicating a likelihood of a class to which the two consecutive elements belong. The first calculation unit 110 may sequentially acquire elements included in the series data from the data acquisition unit 50, and may calculate the individual likelihood ratio based on the two consecutive elements in order, for example. The individual likelihood ratio calculated by the first calculation unit 110 is configured to be outputted to the second calculation unit 120.

The second calculation unit 120 is configured to calculate an integrated likelihood ratio on the basis of a plurality of individual likelihood ratios calculated by the first calculation unit 110. The integrated likelihood ratio is calculated as a likelihood ratio indicating a likelihood of a class to which the plurality of elements that are considered in each of the plurality of individual likelihood ratios, belong. In other words, the integrated likelihood ratio is calculated as a likelihood ratio indicating a likelihood of a class to which the serial data including the plurality of elements, belongs. The integrated likelihood ratio calculated by the second calculation unit 120 is configured to be outputted to the class classification unit 200. The class classification unit 200 classifies the serial data into classes on the basis of the integrated likelihood ratio.

The learning unit 300 according to the fifth example embodiment may perform learning on the entire likelihood ratio calculation unit 100 (i.e., on the first calculation unit 110 and the second calculation unit 120 as a whole), or may perform learning separately on the first calculation unit 110 and the second calculation unit 120. Alternatively, the learning unit 300 may be separately provided as a first learning unit that performs learning only on the first calculation unit 110 and a second learning unit that performs learning only on the second calculation unit 120. In this case, only one of the first learning unit and the second learning unit may be provided.

### (Flow of Classification Operation)

Next, a flow of operation of the classification apparatus 10 (specifically, a class classification operation after learning) in the information processing apparatus 1 according to the sixth example embodiment will be described with reference to FIG. 8. FIG. 8 is a flowchart illustrating the flow of the operation of the classification apparatus in the information processing apparatus according to the sixth example embodiment.

As illustrated in FIG. 8, when the operation of the classification apparatus 10 is started, first, the data acquisition unit 50 acquires the elements included in the series data (step S21). The data acquisition unit 50 outputs the acquired elements of the sequence data to the first calculation unit 110.

The first calculation unit 110 calculates the individual likelihood ratio on the basis of the acquired two consecutive elements (step S22). Thereafter, the second calculation unit 120 calculates the integrated likelihood ratio on the basis of the plurality of individual likelihood ratios calculated by the first calculation unit 110 (step S23).

Subsequently, the class classification unit 200 performs the class classification on the basis of the calculated integrated likelihood ratio (step S24). The class classification may determine one class to which the series data belong, or may determine multiple classes to which the series data are likely to belong. The class classification unit 200 may output a result of the class classification to a display or the like. The class classification unit 200 may also output the result of the class classification by audio through a speaker or the like.

### (Technical Effect)

Next, a technical effect obtained by the information processing apparatus 1 according to the sixth example embodiment will be described.

As described in FIG. 7 and FIG. 8, in the information processing apparatus 1 according to the sixth example embodiment, first, the individual likelihood ratio is calculated on the basis of the two elements, and then, the integrated likelihood ratio is calculated on the basis of the plurality of individual likelihood ratios. By using the integrated likelihood ratio calculated in the above manner, it is possible to properly select the class to which the serial data belong. Furthermore, in the classification apparatus 10 that calculates the individual likelihood ratio and the integrated likelihood ratio, the learning is performed by using the loss function for decomposing the likelihood ratio described in the above example embodiments into the sum of multiple terms, and it is thus possible to realize more appropriate class classification.

### Seventh Example Embodiment

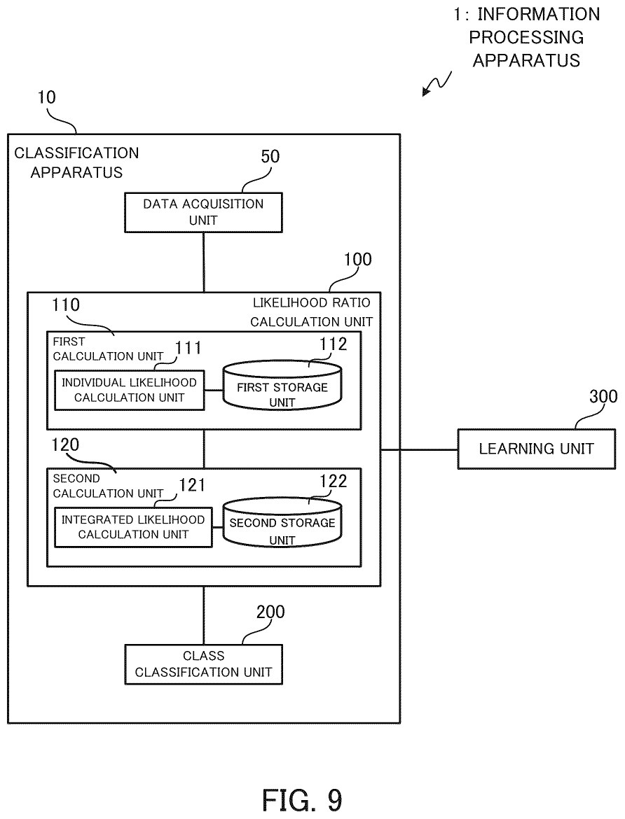

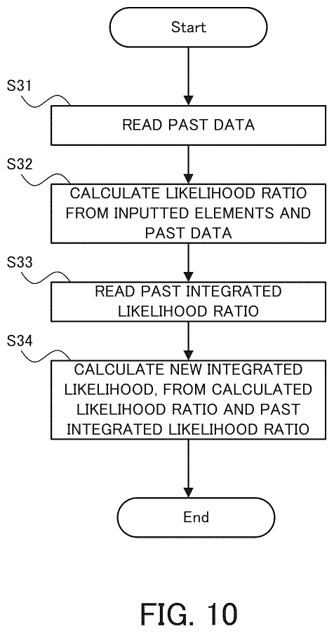

The information processing apparatus 1 according to a seventh example embodiment will be described with reference to FIG. 9 and FIG. 10. The seventh example embodiment is partially different from the sixth example embodiment only in the configuration and operation (specifically, the configuration and operation of the likelihood ratio calculation unit 100), and may be the same as the sixth example embodiment in the other parts. For this reason, a part that is different from each of the example embodiments described above will be described in detail below, and a description of the other overlapping parts will be omitted as appropriate.

### (Functional Configuration)

First, with reference to FIG. 9, a functional configuration of the information processing apparatus 1 according to the seventh example embodiment will be described. FIG. 9 is a block diagram illustrating the functional configuration of the information processing apparatus according to the seventh example embodiment. In FIG. 9, the same components as those illustrated in FIG. 2 and FIG. 7 carry the same reference numerals.

As illustrated in FIG. 9, in the information processing apparatus 1 according to the seventh example embodiment, the likelihood ratio calculation unit 100 of the classification apparatus 10 includes the first calculation unit 110 and the second calculation unit 120. The first calculation unit 110 includes an individual likelihood ratio calculation unit 111 and a first storage unit 112. The second calculation unit 120 includes an integrated likelihood ratio calculation unit 121 and a second storage unit 122. Each of the individual likelihood ratio calculation unit 111 and the integrated likelihood ratio calculation unit 121 may be realized or implemented by the processor 11 (see FIG. 1), for example. Each of the first storage unit 112 and the second storage unit 122 may be realized or implemented by the storage apparatus 14 (see FIG. 1), for example.

The individual likelihood ratio calculation unit 111 is configured to calculate the individual likelihood ratio on the basis of two consecutive elements of the elements sequentially acquired by the data acquisition unit 50. More specifically, the individual likelihood ratio calculation unit 111 calculates the individual likelihood ratio on the basis of newly acquired elements and past data stored in the first storage unit 112. Information stored in the first storage unit 112 is configured to be read by the individual likelihood ratio calculation unit 111. In a case where the first storage unit 112 stores a past individual likelihood ratio, the individual likelihood ratio calculation unit 111 may read the stored past individual likelihood ratio and may calculate a new individual likelihood ratio in view of the acquired elements. On the other hand, in a case where the first storage unit 112 stores the elements themselves acquired in the past, the individual likelihood ratio calculation unit 111 may calculate the past individual likelihood ratio from the stored past elements and may calculate a likelihood ratio for the newly acquired elements.

The integrated likelihood ratio calculation unit 121 is configured to calculate the integrated likelihood ratio on the basis of a plurality of individual likelihood ratios. The integrated likelihood ratio calculation unit 121 calculates a new integrated likelihood ratio by using the individual likelihood ratio calculated by the individual likelihood ratio calculation unit 111 and a past integrated likelihood ratio stored in the second storage unit 122. Information stored in the second storage unit 122 (i.e., the past integrated likelihood ratio) is configured to be read by the integrated likelihood ratio calculation unit 121.

### <Flow of Likelihood Ratio Calculation Operation>

Next, with reference to FIG. 10, a flow of a likelihood ratio calculation operation (i.e., operation of the likelihood ratio calculation unit 100) in the information processing apparatus 1 according to the seventh example embodiment will be described. FIG. 10 is a flowchart illustrating the flow of the operation of the likelihood ratio calculation unit in the information processing apparatus according to the seventh example embodiment.

As illustrated in FIG. 10, when the likelihood ratio computing operation by the likelihood ratio calculation unit 100 is started, first, the individual likelihood ratio calculation unit 111 of the first calculation unit 110 reads the past data from the first storage unit 112 (step S31). The past data may be, for example, a processing result in the individual likelihood ratio calculation unit 111 regarding previous elements that are acquired one time before the elements currently acquired by the data acquisition unit 50 (in other words, the individual likelihood ratio calculated for the previous elements). Alternatively, the past data may be the previous elements themselves acquired one time before the elements currently acquired.

Subsequently, the individual likelihood ratio calculation unit 111 calculates the new individual likelihood ratio (i.e., the individual likelihood ratio for the elements currently acquired by the data acquisition unit 50) on the basis of the elements acquired by the data acquisition unit 50 and the past data read from the first storage unit 112 (step S32). The individual likelihood ratio calculation unit 111 outputs the calculated individual likelihood ratio to the second calculation unit 120. The individual likelihood ratio calculation unit 111 may store the calculated individual likelihood ratio in the first storage unit 112.

Subsequently, the integrated likelihood ratio calculation unit 121 of the second calculation unit 120 reads the past integrated likelihood ratio from the second storage unit 122 (step S33).

The past integrated likelihood ratio may be, for example, a processing result in the integrated likelihood ratio calculation unit 121 regarding the previous elements that are acquired one time before the elements currently acquired by the data acquisition unit 50 (in other words, the integrated likelihood ratio calculated for the previous elements)

Subsequently, the integrated likelihood ratio calculation unit 121 calculates the new integrated likelihood ratio (i.e., the integrated likelihood ratio for the elements currently acquired by the data acquisition unit 50) on the basis of the likelihood ratio calculated by the individual likelihood ratio calculation unit 111 and the past integrated likelihood ratio read from the second storage unit 122 (step S34). The integrated likelihood ratio calculation unit 121 outputs the calculated integrated likelihood ratio to the class classification unit 200. The integrated likelihood ratio calculation unit 121 may store the calculated integrated likelihood ratio in the second storage unit 122.

### (Technical Effect)

Next, a technical effect obtained by the information processing apparatus 1 according to the seventh example embodiment will be described.

As described in FIG. 12 and FIG. 13, in the information processing apparatus 1 according to the seventh example embodiment, after the individual likelihood ratio is calculated by using the past individual likelihood ratio, the integrated likelihood ratio is calculated by using the past integrated likelihood ratio. By using the integrated likelihood ratio calculated in the above manner, it is possible to properly select the class to which the serial data belong. Furthermore, in the classification apparatus 10 that calculates the individual likelihood ratio and the integrated likelihood ratio by using the past data, the learning is performed by using the loss function for decomposing the likelihood ratio described in the above example embodiments into the sum of multiple terms, and it is thus possible to realize more appropriate class classification.

A processing method that is executed on a computer by recording, on a recording medium, a program for allowing the configuration in each of the example embodiments to be operated so as to realize the functions in each example embodiment, and by reading, as a code, the program recorded on the recording medium, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and that executes processing alone, but also the program that operates on an OS and that executes processing in cooperation with the functions of expansion boards and another software, is also included in the scope of each of the example embodiments. In addition, the program itself may be stored in a server, and a part or all of the program may be downloaded from the server to a user terminal.

### <Supplementary Notes>

The example embodiments described above may be further described as, but not limited to, the following Supplementary Notes below.

### (Supplementary Note 1)

An information processing apparatus according to Supplementary Note 1 is an information processing apparatus including: an acquisition unit that acquires a plurality of elements included in series data; a calculation unit that calculates a likelihood ratio indicating a likelihood of a class to which the series data belong, on the basis of at least two consecutive elements of the plurality of elements; a classification unit that classifies the serial data into at least one class of multiple classes serving as classification candidates, on the basis of the likelihood ratio; and a learning unit that performs learning about calculation of the likelihood ratio, by using a loss function for decomposing the likelihood ratio into a sum of multiple terms.

### (Supplementary Note 2)

An information processing apparatus according to Supplementary Note 2 is the information processing apparatus according to Supplementary Note 1, wherein the loss function is a loss function set on an assumption that a prior distribution is uniform.

### (Supplementary Note 3)

An information processing apparatus according to Supplementary Note 3 is the information processing apparatus according to Supplementary Note 2, wherein the loss function includes Kullback-Leibler divergence.

### (Supplementary Note 4)

An information processing apparatus according to Supplementary Note 4 is the Information processing apparatus according to Supplementary Note 1, wherein the loss function is intended to decompose the likelihood ratio into a first likelihood ratio calculated for each of the plurality of elements and a second likelihood ratio calculated for the entire series data.

### (Supplementary Note 5)

An information processing apparatus according to Supplementary Note 5 is the information processing apparatus according to any one of Supplementary Notes 1 to 4, wherein the learning unit performs learning by using another loss function in combination with the loss function for decomposing the likelihood ratio into the sum of multiple terms.

### (Supplementary Note 6)

An information processing method according to Supplementary Note 6 is an information processing method that is executed by at least one computer, the information processing method including: acquiring a plurality of elements included in series data; calculating a likelihood ratio indicating a likelihood of a class to which the series data belong, on the basis of at least two consecutive elements of the plurality of elements; classifying the serial data into at least one class of multiple classes serving as classification candidates, on the basis of the likelihood ratio; and performing learning about calculation of the likelihood ratio, by using a loss function for decomposing the likelihood ratio into a sum of multiple terms.

### (Supplementary Note 7)

A recording medium according to Supplementary Note 7 is a recording medium on which a computer program that allows at least one computer to execute an information processing method is recorded, the information processing method including: acquiring a plurality of elements included in series data; calculating a likelihood ratio indicating a likelihood of a class to which the series data belong, on the basis of at least two consecutive elements of the plurality of elements; classifying the serial data into at least one class of multiple classes serving as classification candidates, on the basis of the likelihood ratio; and performing learning about calculation of the likelihood ratio, by using a loss function for decomposing the likelihood ratio into a sum of multiple terms.

### (Supplementary Note 8)

A computer program according to Supplementary Note 8 is a computer program that allows at least one computer to execute an information processing method, the information processing method including: acquiring a plurality of elements included in series data; calculating a likelihood ratio indicating a likelihood of a class to which the series data belong, on the basis of at least two consecutive elements of the plurality of elements; classifying the serial data into at least one class of multiple classes serving as classification candidates, on the basis of the likelihood ratio; and performing learning about calculation of the likelihood ratio, by using a loss function for decomposing the likelihood ratio into a sum of multiple terms.

### (Supplementary Note 9)

An information processing system according to Supplementary Note 9 is an information processing system including: an acquisition unit that acquires a plurality of elements included in series data; a calculation unit that calculates a likelihood ratio indicating a likelihood of a class to which the series data belong, on the basis of at least two consecutive elements of the plurality of elements; a classification unit that classifies the serial data into at least one class of multiple classes serving as classification candidates, on the basis of the likelihood ratio; and a learning unit that performs learning about calculation of the likelihood ratio, by using a loss function for decomposing the likelihood ratio into a sum of multiple terms.

This disclosure is allowed to be changed, if desired, without departing from the essence or spirit of this disclosure which can be read from the claims and the entire specification. An information processing apparatus, an information processing method, and a recording medium with such changes are also intended to be within the technical scope of this disclosure.

### DESCRIPTION OF REFERENCE CODES

1 Information processing apparatus
10 Classification apparatus
50 Data acquisition unit
100 Likelihood ratio calculation unit
110 First calculation unit
111 Individual likelihood ratio calculation unit
112 First storage unit
120 Second calculation unit
121 Integrated likelihood ratio calculation unit
122 Second storage unit
200 Class classification unit
300 Learning unit

What is claimed is:

1. An information processing apparatus comprising:
at least one memory that is configured to store instructions; and
at least one processor that is configured to execute the instructions to:
acquire a plurality of elements included in series data;
calculate a likelihood ratio indicating a likelihood of a class to which the series data belong, on the basis of at least two consecutive elements of the plurality of elements;
classify the serial data into at least one class of multiple classes serving as classification candidates, on the basis of the likelihood ratio; and
perform learning about calculation of the likelihood ratio, by using a loss function for decomposing the likelihood ratio into a sum of multiple terms.

2. The information processing apparatus according to claim 1, wherein the loss function is a loss function set on an assumption that a prior distribution is uniform.

3. The information processing apparatus according to claim 2, wherein the loss function includes Kullback-Leibler divergence.

4. The Information processing apparatus according to claim 1, wherein the loss function is intended to decompose the likelihood ratio into a first likelihood ratio calculated for each of the plurality of elements and a second likelihood ratio calculated for the entire series data.

5. The information processing apparatus according to claim 1, wherein the at least one processor is configured to execute the instructions to perform learning by using another loss function in combination with the loss function for decomposing the likelihood ratio into the sum of multiple terms.

6. An information processing method that is executed by at least one computer, the information processing method comprising:
acquiring a plurality of elements included in series data;
calculating a likelihood ratio indicating a likelihood of a class to which the series data belong, on the basis of at least two consecutive elements of the plurality of elements;
classifying the serial data into at least one class of multiple classes serving as classification candidates, on the basis of the likelihood ratio; and
performing learning about calculation of the likelihood ratio, by using a loss function for decomposing the likelihood ratio into a sum of multiple terms.

7. A non-transitory recording medium on which a computer program that allows at least one computer to execute an information processing method is recorded, the information processing method including:
acquiring a plurality of elements included in series data;
calculating a likelihood ratio indicating a likelihood of a class to which the series data belong, on the basis of at least two consecutive elements of the plurality of elements;
classifying the serial data into at least one class of multiple classes serving as classification candidates, on the basis of the likelihood ratio; and
performing learning about calculation of the likelihood ratio, by using a loss function for decomposing the likelihood ratio into a sum of multiple terms.
